(19) United States
(12) Patent Application Publication
(10) Pub. No.: US 2010/0323658 A1
(43) Pub. Date: Dec. 23, 2010

(54) PORTABLE EMERGENCY RESPONSE SYSTEM TO ALERT AUTHORITIES OF A MEDICAL ISSUE DURING OUTDOOR ACTIVITIES AND RELATED METHODS

(76) Inventor: Bethany Lagergren, Titusville, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/486,172

(22) Filed: Jun. 17, 2009

(51) Int. Cl. H04M 11/04; G01C 21/00; G01S 1/00; G08B 23/00

(52) U.S. Cl. 455/404.2; 701/209; 340/573.1

(57) ABSTRACT

An emergency response system to alert authorities of a medical issue during an outdoor activity which comprises (a) a portable unit attached to the outdoorsman including an alert button, computer, memory device and power source; (b) a display located on an exterior of the portable unit having one or more buttons to navigate information shown on the display; (c) one or more antennae to communicate with an outside source (which can be GPS) to verify location and (d) means to alert authorities (radio, cellular or satellite) of a medical issue. The invention is also directed to a method comprising the steps of (a) attaching the portable unit, (b) navigating a display, (c) selecting a path, (d) verifying geographic location on a path, and (e) alerting authorities of a medical issue.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF INVENTION

The present invention relates to a portable programmable emergency response system capable of alerting authorities of a medical issue during an outdoor activity. More specifically, the invention provides several methods and systems to contact authorities to provide the precise location of an outdoorsman in the event he or she has been injured or become incapacitated, as well as his or her preexisting health conditions and emergency contact person.

### BACKGROUND OF THE INVENTION

Recreation activities like hiking, biking and horseback riding continue to be ever popular sports. In addition, adventure or so called “extreme” sports like rock climbing, kayaking and rafting have greatly increased in popularity over the past several years. Both recreation and extreme sports generally include some form of outdoor activity where the outdoorsman plots a path or navigates natural terrain. Often, such outdoorsman is far removed from civilization when performing these activities. These sports not only offer the benefit of exercise, but also serenity.

A common and popular type of recreation activity is horseback riding—also known as equestrianism—which includes the sport and skill of riding a horse. Forms of horseback riding include fox hunting, trail riding and hacking. Historians have concluded the sport of trail riding dates back some 6,000 years. Even in today's media-driven society and technology-driven culture, horseback riding remains an ever vibrant sport. In fact, statistics show that each year over 30 million people ride horses.

While horseback riding remains a popular sport in our society, it occasionally results in injury to the outdoorsman. Common injuries from horseback riding include (a) falling from the horse during a ride, (b) being kicked by the horse, (c) being trampled, or (d) suffering a bite from the horse. These injuries result in approximately 50,000 emergency room visits each year. Moreover, statistics suggest 1 in every 600 riders will report some type of injury.

As with other outdoor sports, horseback riding injuries present logistical challenges for authorities as well as dangers to the outdoorsman. Most accidents occur in rural isolated areas, such as a nature preserve, wildlife refuge, or national park. In such locales, it is difficult if not impossible to find the outdoorsman if a medical issue arises. Moreover, the nature of the injury may incapacitate the outdoorsman such that he or she cannot seek medical treatment or contact authorities. With time often of the essence to treat these medical issues, it becomes paramount to not only find the injured outdoorsman but for authorities to surmise if an accident has indeed occurred.

Even with recent advances in cellular communications and the advent of the Global Positioning Satellite system (GPS), problems still exist in alerting authorities as to medical issues resulting from recreation and extreme sport activities. Put simply, carrying a cellular or satellite telephone is not enough. First and foremost, the injury may cause the outdoorsman to become incapacitated and/or incapable of using a cellular or satellite telephone to call authorities. Second, even if he or she was able to place such a call, the injured outdoorsman may be unable to communicate with authorities to provide his or her exact location or cogently converse as to his or her preexisting medical history.

These problems are common to many recreation and extreme sport activities. Accordingly, there is a need in recreation and extreme sport activities for a portable programmable emergency response system capable of alerting authorities in the event an outdoorsman has succumbed to a medical issue. Such system must be capable of being triggered when there is a strong suggestion the outdoorsman is no longer on a pre-specified course, has had a sudden decrease in vertical distance, had an irregular pulse or high body temperature. The system and related method must also be able to locate the outdoorsman so that authorities can provide effective emergency response. In addition, the system should provide authorities with not only the geographic position of the outdoorsman, but also any preexisting medical conditions and his or her emergency contact person.

### SUMMARY OF THE INVENTION

This invention provides a system to alert authorities in the event of an injury to an outdoorsman, including a medical issue which has incapacitated that outdoorsman. The system and related method not only alert authorities, but pinpoints the geographic location of the injured outdoorsman and provides authorities his or her preexisting medical history and the emergency contact person.

In the preferred embodiment, the system includes a portable unit attached to the outdoorsman. The portable unit is worn proximate to the wrist and sufficient to allow viewing during a recreation or extreme sport activity. Internal components of the portable unit include a computer having processing capabilities, a memory device capable of storing coordinates, a self-sufficient rechargeable power source (which can be a battery), and one or more antennae attached to the computer for communicating. On an exterior side of the portable unit, components include an alert button and a display having one or more buttons or touch-activation capabilities to allow the outdoorsman to view a graphical representation of the topography of a path as well as other statistical information. The portable unit can also include multiple sensors to measure exterior temperature, body temperature, pulse and/or a sudden decrease in vertical distance.

As previously discussed, one or more antennae are included within the portable unit to derive information from an outside source to determine geographic location as well as relay information to authorities. Such outside source can be any cellular or satellite system, preferably the GPS system, to verify location on the topography of the outdoor area being traveled. That same (or potentially a second) cellular or satellite system (again potentially GPS enabled) is capable of communicating with an antenna attached to the computer within the portable unit to send an emergency signal to authorities (such as fire rescue, parks service, police or EMTs) through the outdoorsman activating the alert button or based upon a set of previously programmed conditions stored in the the portable unit.

It is likewise preferred that the portable unit has an array of outdoor paths, trails, waterways and streams stored as sets of longitudinal and latitudinal coordinates. These arrays can be stored on the memory device of the portable unit. A program (machine readable code) stored on the memory device and processed by the computer can compare these sets of geographic coordinates to the actual location of the outdoorsman during a recreation or extreme sport activity. Should the outdoorsman depart too far from the coordinates of a selected path, the portable unit detects and verifies the outdoorsman is out of a pre-specified variance through communication with an outside source (i.e., a cellular or satellite system) and sends a warning to the outdoorsman (i.e., an audible noise or vibration), requiring the outdoorsman to press the alert button. If the alert button is not engaged within a pre-specified period of time, the portable unit will contact authorities to provide the exact location of the outdoorsman to send help as well as provide any preexisting medical conditions and/or his or her emergency contact person.

A further preferred component of the portable unit is a sensor which detects if the outdoorsman has had a sudden decrease in vertical distance, which would suggest a fall (i.e., a horseback rider has fallen from a horse or a hiker has fallen down a hill). If a sudden decrease in vertical distance is detected, the portable unit will send a signal to the display alerting the outdoorsman (again, an audible noise or vibration). If the outdoorsman does not activate the alert button within a pre-specified period of time, the portable unit will communicate with an outside source to determine his or her exact coordinates and relay this information to authorities, in addition to the outdoorsman's preexisting medical history and emergency contact person.

In addition to the system, the invention also contemplates a method to alert authorities of a potential medical issue during an outdoor or extreme sport activity. One preferred method includes the steps of attaching the portable unit to the outdoorsman (such as proximate to the wrist); turning the portable unit on; posting on a display within the portable unit one or more navigable paths; selecting a path on the display of the portable unit; verifying a location of the topography of the selected path through communication with an outside source (which can be a cellular or satellite system) through an antenna within the portable unit; and alerting authorities by activating the alert button or based upon previously programmed conditions stored in the memory device.

### BRIEF DESCRIPTION OF THE DRAWINGS

FIG. 1 is a direct view of the internal components of the portable unit, including the computer, memory device, power source, vertical distance sensor, thermo-sensors, pulse monitor and antennae.

FIG. 2 is a direct view of the external components of the portable unit including the alert button, display and navigation buttons.

FIG. 3 shows how the portable unit communicates with one or more outside sources to find the geographic position of the outdoorsman as well as contact authorities as to a medical issue.

FIG. 4 provides an environmental view of how the system employs longitudinal and latitudinal coordinates to plot an outdoor path verified through an outside source.

### DETAILED DESCRIPTION OF THE INVENTION

The present invention relates to a system and method to alert authorities of a medical issue during a recreation or extreme sport activity such as hiking, mountain biking, climbing, horseback riding, canoeing, kayaking or rafting. The invention employs a portable unit 100 capable of communicating with one or more outside sources 200 to determine the geographic location of an outdoorsman, as well as provide authorities 300 his or her precise geographic coordinates in the event of a medical issue. More specifically, the system is capable of graphically displaying the outdoorsman's location of the topography being traveled, calculating the distance traveled, outside temperature, the outdoorsman's body temperature and pulse, as well as determine whether there has been a sudden drop in vertical distance. Should such a drop occur or if the outdoorsman wanders off a pre-specified path, the portable device 100 is capable of alerting authorities of a potential medical issue—even if the outdoorsman becomes incapacitated. In the event of such medical issue, the portable device 100 can relay any preexisting medical condition, current medications, and the outdoorsman's emergency contact person.

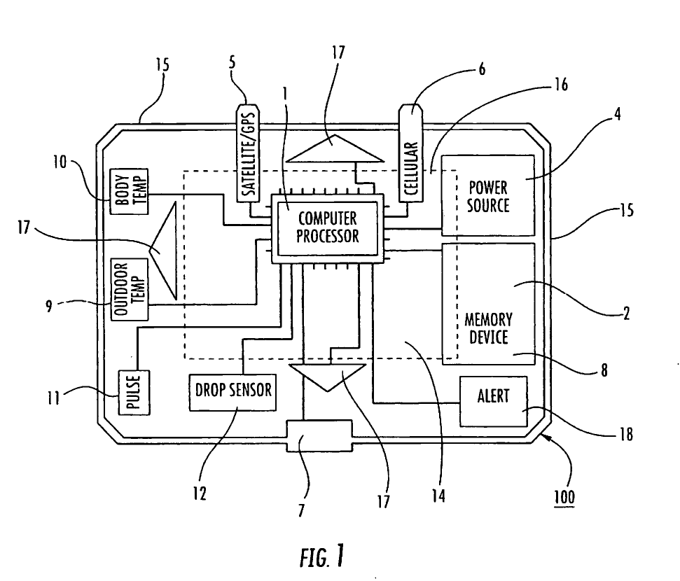

The primary component of the system is a portable unit 100 attached to the outdoorsman during the recreation or extreme sport activity. As best illustrated in FIG. 1, the internal components of the portable unit 100 comprise a computer 1 having processing capabilities, a memory device 2 capable of storing information such as coordinates of a unique outdoor recreation path 3, a self-sufficient rechargeable power source 4 (which can be a battery), and one or more antennae 5 and 6 which connect to the computer 1.

The portable unit 100 of FIG. 1 also includes a serial, USB, Firewire, BlueTooth or similar commercially available interface 7 capable of loading data and/or machine readable code 8 (a computer program) onto the memory device 2. Such portable unit 100 further employs a variety of sensors to gauge physiological conditions—including an outside thermo-sensor 9, a body thermo-sensor 10, a pulse monitor 11, and a vertical drop sensor 12. These physiological conditions are read by the computer 1, based upon machine readable code 8 stored in the memory device 2.

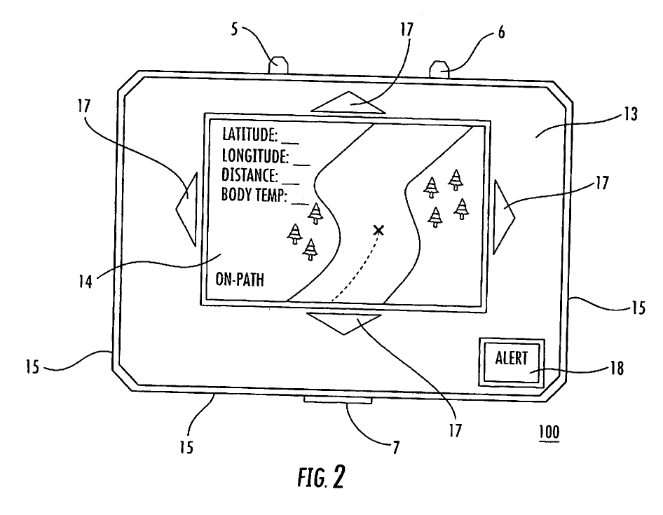

The external components of the portable unit 100 shown in FIG. 2 illustrate a wrist-watch sized apparatus worn proximate to the outdoorsman's wrist. The portable unit 100 may also be affixed to the ankle, forearm or similar location accessible by the outdoorsman during an activity. By way of example, a mountain climber could attach the portable unit 100 to a helmet or head-strap to allow viewing when ascending or descending during a climb.

FIG. 2 also shows the exterior components of the portable unit 100. These include the front side 13 (the back side 14 shown in FIG. 1) and corresponding sidewalls 15 positioned in-between both the front 13 and back 14 sides. Preferably located on the front side 13 of the portable unit 100 is a graphics-capable display 16. The display 16 communicates with the computer 1, antennae 5 and 6, and the memory device 2. Moreover, such display 16 provides key statistics and information to the outdoorsman during an activity including their physical location on the topography of a selected path, trail, stream or waterway (including longitude and latitude coordinates), overall distance travelled, outdoor and body temperature, and his or her current pulse.

Preferably positioned at each of the four sides of the display 16 are push buttons 17 to allow the outdoorsman to select information available from the portable unit 100. This can include viewing (and scrolling through) a graphical representation of the topography being traveled through use of geographic coordinates obtained from the antenna 5 and read by the computer 1. As also illustrated in FIG. 1, each push button 17 communicates with the computer 1, memory device 2 and antennae 6 to obtain and illustrate pre-programmed paths, trails, streams and waterways on the display 16. Thus, the push buttons 17 allow the outdoorsman to request data from the portable device 100 to be shown through the display 16, including selection of a pre-programmed course upon which to travel, overall distance traversed, pulse and outdoor and body temperature. Instead of using push buttons 17, the display 16 can be touch or pressure sensitive. The front side 13 preferably includes an alert button 18 of sufficient size and dimension to be easily located and engaged in the event of a medical issue. If the outdoorsman presses the alert button 18, a signal is sent to the computer 1. Upon accessing machine readable code 8 (a computer program) located on the memory device 2, the computer 1 will send a signal through the antennae 6 to an outside source 200 sufficient to contact authorities 300. In other embodiments of the system, either the push buttons 17 and/or the touch activated display 16 can serve as the alert button 18.

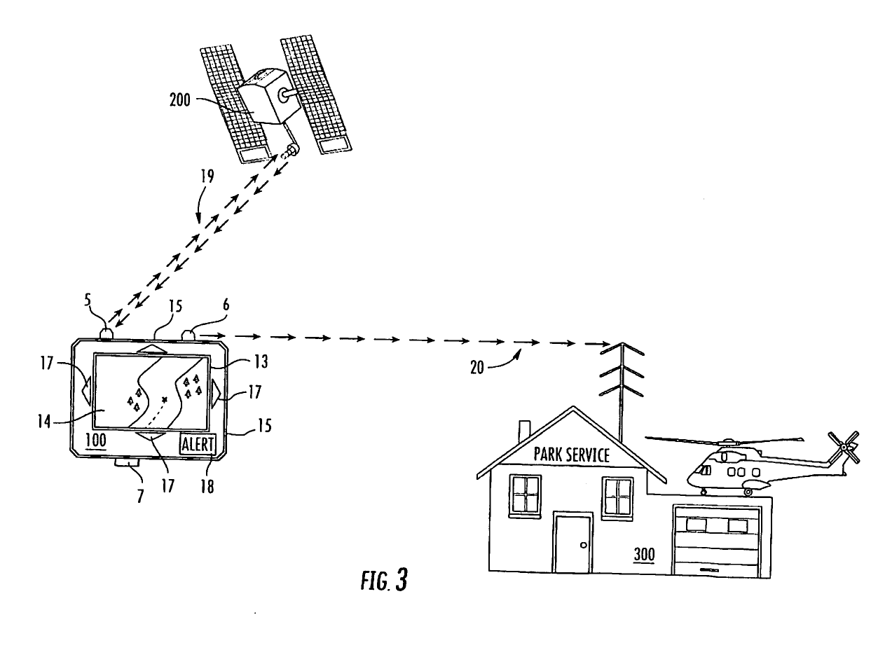

Now referring to FIG. 3, another important capability of the portable unit 100 is communication with one or more outside sources 200. One outside source 200 allows two-way communication 19 between an antenna 5 and a cellular or satellite system 20 sufficient to determine the exact geographic position of the outdoorsman during a recreation or extreme sport activity. As also shown in FIG. 1, this two-way communication 19 allows the antenna 5 to acquire the longitudinal and latitudinal coordinates of the portable device 100, which are relayed through the computer 1 to machine readable code 8 (again, a computer program) located on the memory device 2. This machine readable code 8 then displays the location of the outdoorsman of the topography of the trail or waterway traveled through a graphic illustration provided on the display 16 shown in FIG. 2. Moreover, these geographic coordinates are capable of being stored within the memory device 2 to determine overall distance traversed, average speed of the outdoorsman, and related statistical information regarding the activity.

The portable unit 100 also communicates with authorities 300, such as police, fire rescue, EMTs and/or the parks service to report a medical issue. FIG. 3 likewise illustrates how an antenna 6 of the portable unit 100 can send a communication 20 to authorities 300 to provide the coordinates of the portable unit 100, as well as any preexisting medical condition and the outdoorsman's emergency contact person.

Transmission of the data can occur by the outdoorsman pressing the alert button 18 to send the communication 20 to authorities 300. Upon engaging the alert button 18, the display 16 can post what information was sent to authorities 300 (i.e., coordinates and preexisting medical conditions), as well as whether the communication 20 was indeed successful. As shown in FIG. 1, this occurs through machine readable code 8 (again, a program) processed by the computer 1 to send a communication 20 through the antenna 6. In the alternative, only one antenna 5 could be used in the portable device 100 to send the communication 20. Under either scenario, the communication 20 to authorities 300 can be through radio, cellular, satellite or any other signal available to one of ordinary skill in the art.

As shown in FIG. 1 and FIG. 3, the system must be capable of having the portable device 100 relay a communication 20 to authorities 300 to provide the exact longitude and latitude of the outdoorsman in the event of a medical issue. The communication 20 can also include information in addition to pre-existing medical conditions, including age, sex, height, weight, body fat index, and medications—all of which are stored on the memory device 2. Such medical information can be loaded onto the memory device 2 of the portable unit 100 via the interface 7 shown in FIG. 1 and FIG. 2.

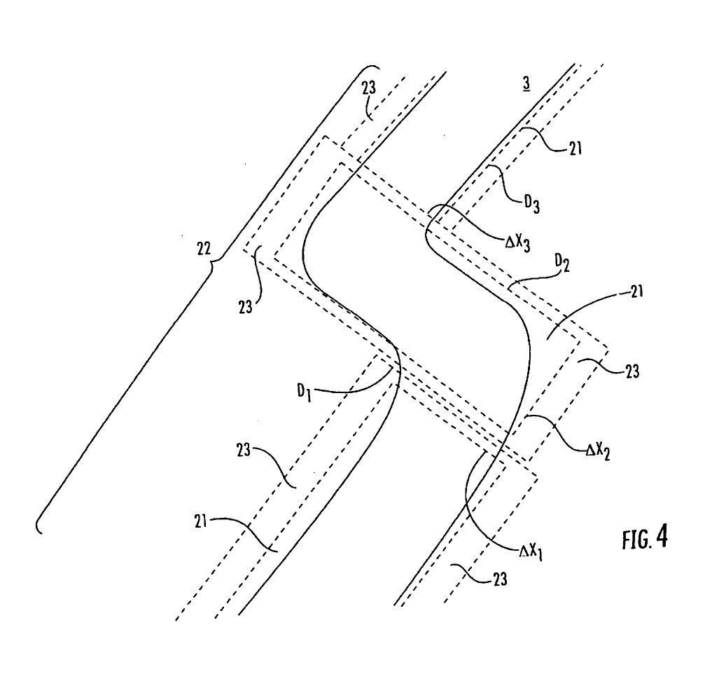

The interface 7 is also capable of loading various paths 3, trails, streams, waterways and climbing charts onto the memory device 2 of the portable unit 100. The interface 7 can be any serial, USB, Firewire, BlueTooth or commercially available device capable of uploading or downloading data. FIG. 4 offers one example of associating coordinates sufficient to plot a path 3, trial or waterway. First, the terrain of the path is divided into discrete linear segments 21 of varying widths (ΔX_{y}) and lengths (D_{z}). Each segment 21 is essentially rectangular or square in size and dimension. Second, based upon the width ΔX_{y} and length (D₁, D₂ or D₃) of each segment 21, the computer 1 uses machine readable code 8 stored in the memory device 2 to calculate the appropriate coordinates within each segment 21. Third, a collection of segments 22 aggregate to form a defined path 3.

Based upon this collection of segments 22 forming a defined path 3, the portable unit 100 can communicate 19 with an outside source 200 to ensure the outdoorsman is within a defined variance 23 in each segment 21. The variance 23 is typically of a larger length and width than the related segment 21. Should the outdoorsman stray outside a segment 21—suggesting a potential medical issue—a comparison is made between coordinates provided by the outside source 200 (again, a cellular or satellite system) and those deemed within the variance 23 of the segment 21 where the outdoorsman is located.

If the outdoorsman wanders outside the variance 23, the computer 1 detects this deviation and can send a warning to the display 16. The computer 1 may also warn the outdoorsman through creating an audible alarm or vibration within the portable device 100. Through machine readable code 8 processed by the computer 1, if the outdoorsman presses either the alert button 18 or other push buttons 17 located on the front side 13 of the portable unit 100 within a pre-specified period of time (i.e., 90 seconds) the system acknowledges he or she is ok and not suffering a medical issue. Otherwise, the portable device 100 will communicate 19 with an outside source 200 to verify the latitude and longitude of the outdoorsman. Next, the portable device 100 based upon this detected deviation will communicate 20 to authorities 300 not only these geographic coordinates, but also the outdoorsman's preexisting medical history and emergency contact person.

As show in FIG. 1, the portable unit 100 further comprises a vertical drop sensor 12, which detects whether the outdoorsman has experienced a sudden drop in vertical distance. Such a drop could be attributable to a climber losing his or her footing, a kayaker traversing a waterfall, or a horseback rider being dislodged from the horse. The vertical drop sensor 12 alerts the computer 1 of a potential fall, which then is posted on the display 16. More specifically, the vertical distance sensor 12 sends a signal to the computer 1 which accesses machine readable code 8 stored within the memory device 2. The computer 1 compares the deviation reported by the vertical drop sensor 12, against the acceptable variance 23 provided within the machine readable code 8. Based upon the activity pre-selected by the outdoorsman, the defined acceptable drop will vary. Should the drop be greater than the allowed value, the computer 1 will send an alert based upon this detected deviation through the display 16, asking the outdoorsman to push the alert button 18 (or other push buttons 17) to confirm he or she is ok. In the alternative, the alert can be an audible sound or vibration in the portable device 100. If the outdoorsman pushes the button 17 or 18 within a pre-specified amount of time, the portable unit 100 will accept that the outdoorsman is safe. Otherwise, the portable unit 100 will communicate 20 via an antenna 6 with authorities 300 to provide the last known geographic coordinates of the outdoorsman, and provide his or her preexisting medical history and emergency contact person.

In addition to the system, the invention proscribes a method to alert authorities 300 of a medical issue during a recreation or extreme sport activity. Under the preferred method, the outdoorsman first attaches the portable unit 100 onto his or her body—preferably proximate to the wrist. The outdoorsman can also attach the portable unit 100 anywhere it is visibly accessible yet will not impede or interfere with the underlying activity. Second, the outdoorsman should turn the portable device 100. Next, the portable device 100 posts on the display 16 available paths 3 in that geographic area upon which to travel. Fourth, the outdoorsman selects on the portable device 100 the type of activity (such as rafting, hiking, biking or horseback riding), as well as path 3 her or she would prefer to traverse.

Once the path 3 is selected from the display 16 prompt, the outdoorsman can begin his or her activity. Throughout the activity, the portable device 100 communicates 19 with an outside source 200 to verify the geographic coordinates of the outdoorsman—which are posted on the display 16. In addition, the portable unit 100 updates the outdoorsman as to his or her distance traveled, the outdoor temperature, his or her body temperature and pulse.

Throughout the outdoorsman's traverse of the path 3, the portable unit 100 constantly communicates 19 with the outside source 200 to verify the longitude and latitude of the outdoorsman. Likewise, the computer 1 routinely accesses machine readable code 8 from the memory device 2 to measure whether those geographic coordinates fall within an acceptable variance 23 of each segment 21 of the path 3. Again this is done through measuring each aforementioned segment 21 defined by varying widths (ΔX_{y}) and lengths (D_{z}) stored in the memory device 2 and accessed by the computer 1. Based upon these measurements, the computer 1 detects whether the outdoorsman has deviated too far outside a segment 21 through communicating 19 with an outside source 200. By calculating whether the outdoorsman is outside a variance 23, the computer 1 based upon this detected deviation will instruct the portable unit 100 to alert the outdoorsman through the display 17, audible alarm, vibration or combination thereof. If the outdoorsman fails to push either the alert button 18 or push buttons 17 within a pre-specified period of time (i.e., 90 seconds), the portable unit 100 alerts authorities 300 through communicating 20 through an antenna 6. This communication 20 includes forwarding pre-existing medical conditions and the outdoorsman's emergency contact person. It can also include the outdoorsman's age, sex, height and body fat index.

If a vertical drop sensor 12 attached to the portable device 100 measures a significant drop in vertical distance, the computer 1 will measure this deviation through accessing machine readable code 8 stored on the memory device 2. If this drop is greater than allowed by the machine readable code 8, the computer 1 alerts the outdoorsman via the display 16 of this detected deviation through an audible alarm, vibration or combination thereof. Again, if the outdoorsman fails to push either the alert button 18 or push buttons 17 within a pre-specified period of time, the portable unit 100 alerts authorities 300 through communicating 20 via antenna 6.

The method further contemplates monitoring the physiology of the outdoorsman as he or she traverses the path 3. This includes measuring the outside temperature, as well as the outdoorsman's body temperature and pulse. This is all done through the computer 1 communicating with various thermo-sensors 9 and 10, as well as a pulse monitor 11. Through the computer 1 accessing machine readable code 8, the system can review output from the thermo-sensors 9 and 10 and pulse monitor 11, to determine if a heart attack or heat related condition (i.e., heat stroke) is occurring. If the computer 1 determines a medical issue, the portable device 100 will alert the outdoorsman through the display 16 that they may be suffering from a heart or heat related illness. This alert can again be through an audible alarm or vibration in the portable unit 100. If the outdoorsman fails to push either the alert button 18 or push buttons 17, the portable unit 100 alerts authorities 300 via the antenna 6. Specifically, the antenna 6 can send a radio, cellular, satellite or related type signal to authorities 300. This signal can include pre-existing medical conditions and the outdoorsman's emergency contact person.

That which is claimed is:

1. An emergency response system to alert authorities that an outdoorsman has suffered a medical issue during an activity, comprising:
a portable unit having an alert button, a computer, a memory device coupled to the computer and a power source;
a display located on an outer side of the portable unit capable of posting information;
a first antenna connected to the portable unit capable of communicating with an outside source to verify the geographic coordinates of the outdoorsman; and
a second antenna connected to the portable unit capable of alerting authorities through activating the alert button and a detection by the portable unit of a medical issue through previously programmed conditions stored in the memory device.

2. The system recited in claim 1, further comprising:
means for placing geographic coordinates of an array of varying paths in the memory device readable by the computer of the portable unit.

3. The system recited in claim 2, further comprising:
means for detecting when the outdoorsman departs from the geographic coordinates of a path;
means for providing a deviation warning to the outdoorsman that he or she has deviated from the geographic coordinates of the path; and
means for alerting authorities if the alert button is not engaged within a pre-specified period of time following the deviation warning.

4. The system recited in claim 1, wherein:
said portable unit includes a sensor to determine if the portable unit has experienced a sudden decrease in vertical distance;
means for warning the outdoorsman; and
means for alerting authorities if the alert button is not engaged within a pre-specified period of time.

5. The system recited in claim 1, further comprising:
means for attaching the portable unit proximate to the wrist of the outdoorsman.

6. The system recited in claim 1, wherein:
said outside source is the Global Positioning Satellite (GPS) system.

7. The system recited in claim 1, wherein:
said portable unit also includes one or more thermo-sensors capable of measuring the outside temperature and the outdoorsman's body temperature.

8. The system recited in claim 7, wherein:
said portable unit further includes a pulse monitor capable of measuring the outdoorsman's heartbeat.

9. An emergency response method to alert authorities that an outdoorsman has suffered a medical issue during an activity, comprising the steps of:
(a) attaching a portable unit to the outdoorsman, said portable unit having an alert button, a display, a computer, a memory device coupled to the computer and a power source;
(b) posting on the display one or more navigable paths;
(c) selecting a path on the display of the portable unit;
(d) verifying a location of the topography of the selected path through communication with an outside source through an antenna within the portable unit; and
(e) alerting authorities by activating the alert button or based upon previously programmed conditions stored in the memory device.

10. The method of claim 9, further comprising the steps of:
determining the geographic coordinates of a path;
placing the geographic coordinates of the path in the memory device of the portable unit; and
retrieving the geographic coordinates from the memory device during an activity and graphically illustrating the topography represented by those geographic coordinates on the display.

11. The method of claim 10, further comprising the steps of:
detecting through use of the computer within the portable unit whether the outdoorsman has deviated from the geographic coordinates of the path;
warning the outdoorsman of the detected deviation;
requesting that the outdoorsman activate the alert button to verify the outdoorsman has not suffered a medical issue; and
alerting authorities if the outdoorsman does not press the alert button within a pre-specified period of time.

12. The method of claim 9, further comprising the steps of:
detecting whether the outdoorsman has experienced a sudden decrease in vertical distance;
warning the outdoorsman of the vertical distance derivation;
requesting that the outdoorsman activate the alert button to verify the outdoorsman has not suffered a medical issue; and
alerting authorities if the outdoorsman does not press the alert button within a pre-specified period of time.

13. The method of claim 9, wherein:
said portable unit includes a display having touch-activation capabilities.

14. The method of claim 9, further comprising the step of:
attaching the portable unit proximate to the outdoorsman's wrist.

15. The method of claim 9, wherein:
said outside source is the Global Positioning Satellite (GPS) system.

16. The method of claim 9, further comprising the step of:
tracking distance traveled by the outdoorsman during an activity.

17. The method of claim 16, further comprising the step of:
posting the distance traveled on the display of the portable unit.

18. The method of claim 9, further comprising the step of:
measuring the body temperature of the outdoorsman.

19. The method of claim 18, further comprising the steps of:
detecting through the computer of the portable unit whether the outdoorsman is experiencing a heat related condition;
warning the outdoorsman that he or she may be experiencing a heat related condition; and
alerting authorities that the outdoorsman is suffering from a heat related condition.

20. The method of claim 9, further comprising the steps of:
measuring the outdoorsman's pulse;
detecting through the computer of the portable unit whether the outdoorsman is suffering from a heart condition;
warning the outdoorsman that he or she may be suffering from a heart condition; and
alerting authorities that the outdoorsman is suffering from a heart condition.
